(19) United States
(12) Patent Application Publication
(10) Pub. No.: US 2009/0232285 A1
(43) Pub. Date: Sep. 17, 2009

(54) METHOD AND SYSTEM FOR PROVIDING PERSONALLY ENDORSED ADVERTISING CONTENT TO A CALLING PARTY

(76) Inventor: Babu Mani, Murphy, TX (US)

Correspondence Address: ERICSSON INC., 6300 LEGACY DRIVE, M/S EVR 1-C-11, PLANO, TX, 75024, US

(21) Appl. No.: 12/048,083

(22) Filed: Mar. 13, 2008

(51) Int. Cl. H04M 11/00

(52) U.S. Cl. 379/88.18

(57) ABSTRACT

A method and system of providing personally endorsed advertising content to a calling party in lieu of a ring back tone (RBT). The method and system is further adapted to apply rules selected by a subscriber in connection with the provision of personally endorsed advertising content to a calling party.

### BACKGROUND

The present invention relates to telecommunication systems. More particularly, and not by way of limitation, the present invention is directed to a method and system for providing a calling party an advertisement having a personal endorsement of the called party in lieu of a ring back tone (RBT). As used herein, the following abbreviations shall have the following meanings:
AT—Answer Tones
CRBT—Color Ringback Tone
MSC—Mobile Switching Center
RBT—Ringback Tone
SCP—Service Control Point

In a call made over a telecommunications system using a wireless infrastructure, wireline infrastructure or both, a calling party uses the telecommunication infastructure to signal a called party. The party that initiates the call is referred to as the caller or calling party, and the party receiving the call is referred to as the called party, terminating party or subscriber. As used herein, it is assumed that the subscriber and the called party are the same person.

RBT is a service provided to the subscribers of telecommunication service providers that enables the subscribers to substitute the regular audible ringing provided to a calling party with a tone or audio clip selected by the called party during the process of connecting a call. This service is also known as Color Ringback Tones (CRBT) and Answer Tones (AT). It is also possible to substitute the tone or the audio clip with other media content. Thus the RBT content presented to callers can be video, text, graphics, photos, etc., only limited by the capabilities of the caller's handset and the transmission capabilities of the telecommunications network. RBT is a terminating service. In other words, the terminating user is the called party who subscribes to the RBT service and callers listen to RBT content as specified by the subscriber who is the called party.

Currently, the RBT service selects a song as the RBT that is played to the calling party as determined by the subscriber. In other words, the RBT is pre-assigned by the subscriber and may be based on certain parameters. Typically, such parameters include the identity of the caller, the time of day, and a random selection from a list of songs that the subscriber has purchased. Further, it is known to provide advertisements to the calling party in lieu of a RBT. Payback has been accepted as a viable means to attract new subscribers, wherein generic advertisements take the place of RBT content. Conventional RBT service is an expense to a subscriber.

However, conventionally, there is no means for associating a personal endorsement of the called party with an advertisement. What is desired is a method and system that associates a personal endorsement of the subscriber with an advertisement which is played to the calling party.

### SUMMARY

Advertisements often have a celebrity endorsement. However, depending on the audience, such celebrity may have little or no influence over the listener. A more influential endorsement may be that of a called party, who likely already has a pre-existing relationship with the calling party. This relationship may be personal or business in nature. As such, the nature of the relationship can play an important role in influencing the calling party in purchasing a good or service or in influencing their thoughts or actions. The present invention is the use of a personal endorsement of a subscriber which is played, in lieu of a RBT, to a calling party while the calling party is waiting to be connected to the called party.

As noted, conventional RBT service is an expense to an RBT subscriber. In contrast, a business model implementing the present invention can be structured to generate revenue for the subscriber.

### BRIEF DESCRIPTION OF THE SEVERAL VIEWS OF THE DRAWINGS

FIG. 1 is a flow chart of an embodiment of the method is adapted to provide personally endorsed advertising content of a subscriber to the calling party; and

FIG. 2 is a block diagram of an embodiment of the system used to implement the present invention.

### DETAILED DESCRIPTION

The present invention provides a caller to a calling party, advertisements that have been personally endorsed by the subscriber. A caller calling a subscriber who has subscribed to the service implemented by the present invention will receive advertising content that has been personally endorsed by the subscriber.

When provisioning, the subscriber can select the advertising content that is to be personally endorsed, or can generate their own advertising content to be personally endorsed. The advertising content is not limited to audio content, but can be any media which can be received and decoded by a terminal, such as a digital photograph or streaming video. The advertising content can be stored locally or can be streamed. The present invention can further provide the subscriber with a variety of rules governing the treatment: provide the personally endorsed advertising content only to selected callers; select different advertising content based on the identification of the caller, for example, if the caller is a business partner, the party could select one personally endorsed advertisement and if a family member, another personally endorsed advertisement; and turn on or off the advertisement on an ad hoc basis. The content of the personally endorsed advertising content can be a product or service advertisement or can be a political, social or non-profit related advertisement. Other rules available to a subscriber include: ability to add a personal recording to the advertising content offered as an RBT content; selecting a generic endorsement announcement, such as a carrier recorded endorsement having, e.g., a personally recorded name, followed by carrier recorded endorsement, followed by advertising content; election to skip advertising content; ability to vary an endorsement, that is to make the recommendation strong, weak, or normal; ability to select advertising content; ability to randomly select from a pool of pre-selected advertising content and ability to select ads based on ratings assigned by carrier and/or a content provider).

More specifically, the present invention is a method and system for providing advertising content personally endorsed by the subscriber to the caller in a wireless system in which a terminal is in communication with a functional node of the system such as a service platform, an application server or service control point that implements RBT service. The personally endorsed advertising content is maintained on an application server and is provided to a calling party based on the rules selected by the subscriber. Alternatively, the present invention is a node coupled to a telecommunication system the node adapted to provide the personally endorsed advertising content of a subscriber to a calling party.

In operation, a terminating exchange queries the application server as to whether a subscriber has subscribed to the service provided by the present invention, and if so, whether a specific calling party is to be provided the personally endorsed advertising content. The service provided by the present invention can be provisioned by the subscriber, e.g., through an Internet portal, or by contacting the subscriber's service provider, who then sets up the service. During provisioning, the rules governing the provision of personally endorsed advertising content can be selected by the subscriber. The present invention can be implemented on any server or service platform that implements RBT selection.

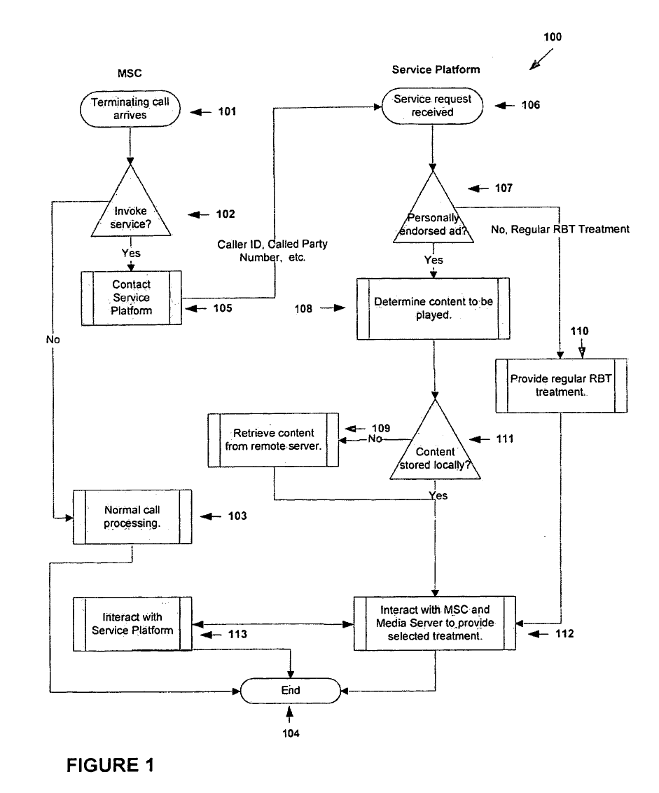

Referring to FIG. 1, a first embodiment of the present invention 100 is presented. As seen therein, a caller attempts to signal a subscriber and the call setup request arrives at a first node, such as an MSC, at step 101. In step 102, it is determined whether the subscriber has subscribed to intelligent network services. If the subscriber has not subscribed to intelligent network services, then in step 103, conventional call processing occurs and the method terminates at step 104. If the subscriber has subscribed to intelligent network services, then in step 105, a first node, such as a service platform, is contacted and the service request is received at step 106. The service platform then determines, at step 107, whether call treatment based on the subscriber's personally endorsed advertising content is to be invoked. If not, then in step 110, regular RBT treatment can be provided to the calling party through the interaction in steps 112 and 113 of at least one server, such as a media server, the service platform and the first node. The method then terminates at step 104. If it is determined that the functionality of the present invention is to be invoked in step 107, then in step 108 it is determined which personally endorsed advertising content to provide to the calling party. The application server determines the advertising content to be provided based on the rules selected by the subscriber, e.g., the characteristics of the called party. In step 111, it is determined if the advertising content, and optionally, the personal endorsement, to be retrieved is stored locally. If so, then it is retrieved from the local server. If the advertising content, and optionally, the personal endorsement are not stored locally, it is retrieved from a remote server in step 109. Once the advertising content is retrieved it is correlated with the personal endorsement and provided to the calling party through the interaction in steps 112 and 113 of at least one server, such as a media server, the service platform and the first node.

In providing the personally endorsed advertising content, the media server can stream the advertising content from a content server. The personal endorsement can be a personal recording or a recording selected by the subscriber. Also, upon receiving the service request at the service platform, an application server can query its database to determine the rule or rules that the subscriber has specified for the treatment of the call that is being placed. In this manner, the treatment is based on the personal preferences of the subscriber. Once the personally endorsed advertising content is provided by the application server to the calling party in steps 112 and 113, the method terminates at step 104.

The servers can each be an application server, a service control point, a service control point working in conjunction with an interactive voice response (IVR) unit, a media server, an intelligent peripheral (IP) player, a database with subscription information and a database with personally endorsed advertising content. The application server alone or with other servers, hosts computer software that implements the present invention.

The method of the present invention includes the following steps: determining whether intelligent network services are to be invoked at a first node and if not, then processing the call in a conventional manner. If intelligent network services are to be invoked, a second node is contacted and it is determined, at the second node, if call treatment based on the called party's personal endorsement of advertising content is to be invoked. If not, then the call is processed using conventional ring back tone (RBT) treatment. If call treatment is to be based on the called party's personal endorsement of advertising content, then the advertising content to be provided is obtained from a first server, and the subscriber's personal endorsement is obtained from a second server. The personal endorsement is correlated with the advertising content and the subscriber's personally endorsed advertising content is provided to the calling party. In a further embodiment, the method includes the step of defining a set of rules for the treatment of a call based on rules selected by the subscriber.

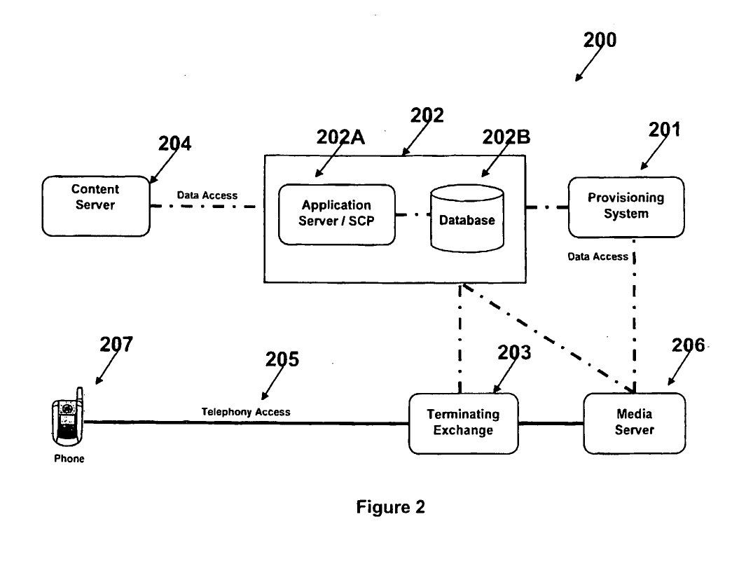

FIG. 2 is a block diagram of a system 200 that can be used to implement the present invention. As seen therein, the subscriber subscribes to the service provided by the present invention over a provisioning system 201. The provisioning system 201 is coupled to an application server/SCP/database 202 and a media server 206. The application server/SCP/database 202 is further coupled to content server 204, which stores the advertising content and media server 206 which stores the personal endorsement. Alternatively, the content server and media server can be the same server. The servers can each be an application server, a service control point, a service control point working in conjunction with an interactive voice response (IVR) unit, a media server, an intelligent peripheral (IP) player, a database with subscription information and a database with personally endorsed advertising content. Generally, the application server/SCP 202A and database 202B maintain the set of rules for the treatment of a call based on rules selected by the subscriber. If the subscriber has subscribed to the service provided by the present invention, application server/SCP 202A receives a service request. The application server/SCP 202A is a functional node of a telecommunications system and includes, but is not limited to, a service platform, an application server or service control point. Based on rules stored in, and invoked from database 202B, the application server/SCP 202A requests the terminating exchange 203 to connect the calling party to media server 206, so that it can play or display the advertising content from the content server 204 with the personal endorsement from the media server 206. Application server/SCP 202A includes server/SCP 202A includes a computer program therein adapted to associate the set of rules with the, e.g., the identification of a calling party.

The present invention can be maintained in a node for handling calls in a telecommunications system or distributed over several nodes, the nodes including at least a means for maintaining the set of rules for the treatment of a call and the means for associating the set of rules with personal endorsements of a subscriber and advertising content. Further, the present invention can be embodied in a computer program adapted to be loaded into at least one memory and executed by at least one processor, the program being adapted to correlate a set of rules selected by a subscriber with personally endorsed advertising content to be provided to a calling party.

While particular embodiments of the present invention have been described, it is not intended that the present invention be limited thereto, as it is intended that the invention be as broad in scope as the art will allow and that the specification be read likewise. While the apparatus of the invention is shown in block diagram format, it will be appreciated that the block diagram may be representative of and implemented by hardware, software, firmware, or any combination thereof. Moreover, the functionality of certain aspects of the block diagram can be obtained by equivalent or suitable structure. It will therefore be appreciated by those skilled in the art that yet other modifications could be made to the provided invention without deviating from its spirit and scope as claimed.

What is claimed:

1. A method of providing ring back tone (RBT) content to a calling party, comprising the steps of:
correlating a personal endorsement of a subscriber to adverting content; and
providing the correlated personally endorsed advertising content to a calling party in lieu of a RBT.

2. The method of claim 1, further comprising the step of applying rules selected by a subscriber in connection with the provision of advertising content to a calling party.

3. The method of claim 1, wherein the selection of personally endorsed advertising content is dependent on the identification of the calling party.

4. The method of claim 1, wherein the advertising content is one from the group consisting of: product advertising content, service advertising content, political advertising content, social advertising content and non-profit organization advertising content.

5. A method in a telecommunications system of providing notification to a calling party that a called party is being signaled, comprising the steps of:
determining whether intelligent network services are to be invoked at a first node;
if not, then processing the call in a conventional manner;
if intelligent network services are to be invoked, contacting a second node;
determining, at the second node, if call treatment based on the called party's personal endorsement of advertising content is to be invoked;
if not, then processing the call using conventional ring back tone (RBT) treatment;
if call treatment is to be based on the called party's personal endorsement of advertising content, then obtaining the advertising content to be provided from a first server;
obtaining the subscriber's personal endorsement from a second server;
correlating the personal endorsement with the advertising content
providing the subscriber's personally endorsed advertising content to the calling party.

6. The method of claim 5, further comprising the step of defining rules by the subscriber which determine how, which and/or when personally endorsed advertising content is to be provided to a calling party.

7. The method of claim 5, wherein the first node is an MSC and the second node is a service platform.

8. The method of claim 7, wherein the first server and the second server can be the same server or separate servers and are selected from the group consisting of: an application server, a service control point, a service control point working in conjunction with an interactive voice response (IVR) unit, a media server, an intelligent peripheral (IP) player, a database with subscription information and a database with personally endorsed advertising content.

9. The method of claim 5, further comprising modifying the subscriber's personally endorsed advertising content provided to a calling party based on at least one rule selected by a subscriber.

10. The method of claim 9, wherein the at least one rule selected by the subscriber is at least one of: selecting the type of personally endorsed advertising content; selecting the callers to whom to play the personally endorsed advertising content; selecting the personally endorsed advertising content based on the identification of the caller; and activating or deactivating the personally endorsed advertising treatment.

11. A method of providing ring back tone (RBT) content to a calling party, comprising the steps of:
defining a set of rules for the treatment of a call based on rules selected by the subscriber;
allowing a subscriber to associate the set of rules with personally endorsed adverting content;
accessing, by a service platform, the personally endorsed adverting content; and
handling the call in accordance with the rules selected to apply to the call.

12. A system for providing ring back tone (RBT) treatment to a calling party comprising:
an application server/SCP/database adapted to receive and maintain a set of rules for delivering advertising content to a calling party;
a first server for storing or fetching advertising content coupled to the application server/SCP/database; and
a second server for storing or fetching personal endorsements of a subscriber coupled to the application server/SCP/database; and
the application server/SCP/database adapted to receive and correlate personal endorsements of a subscriber to the advertising content.

13. The system of claim 12, wherein the first server and the second server can be the same server or separate servers and are selected from the group consisting of: an application server, a service control point, a service control point working in conjunction with an interactive voice response (IVR) unit, a media server, an intelligent peripheral (IP) player, a database with subscription information and a database with personally endorsed advertising content.

14. The system of claim 12, wherein at least one rule in the set of rules to be selected by the subscriber is at least one of: selecting the type of personally endorsed advertising content; selecting the callers to whom to play the personally endorsed advertising content; selecting the personally endorsed advertising content based on the identification of the caller; and activating or deactivating the personally endorsed advertising treatment.

15. The system of claim 12, further comprising a provisioning system adapted to permit a subscriber to subscribe to subscriber endorsed advertising treatment.

16. The system of claim 15, wherein the provisioning system is coupled to the application server/SCP/database.

17. The system of claim 12, wherein the personally endorsed advertising content is any media including audio and/or video content.

18. A node for handling calls in a telecommunications system, comprising
means for maintaining a set of rules for the treatment of a call; and
means for associating the set of rules with personally endorsed advertising content stored or fetched from the node.

19. Computer program code embodied on a computer readable medium and adapted to be loaded into at least one memory and executed by at least one processor, the program being adapted to accept personally endorsed advertising content and correlate it with a set of rules selected by a subscriber.

20. The computer program code of claim 19, wherein the personally endorsed advertising content is any media including audio and/or video content.
